(19) United States
(12) Patent Application Publication
(10) Pub. No.: US 2013/0192111 A1
(43) Pub. Date: Aug. 1, 2013

(54) ADVERTISING MEDIA

(71) Applicant: Michael R. Kennedy, Gates Mills, OH (US)

(72) Inventor: Michael R. Kennedy, Gates Mills, OH (US)

(73) Assignee: THE KENNEDY GROUP INCORPORATED, Willoughby, OH (US)

(21) Appl. No.: 13/417,953

(22) Filed: Mar. 12, 2012

Related U.S. Application Data
(60) Provisional application No. 61/592,705, filed on Jan. 31, 2012.

(51) Int. Cl. G09F 3/10; G09F 3/02

(52) U.S. Cl. 40/638; 40/674

(57) ABSTRACT

Advertising media for application to a substrate includes a release liner and a multi-part label. The multi-part label has a base label and a top label, both of which are coupled with an adhesive. A first adhesive has properties that allow the base label to be removed from the release liner and applied to a substrate or product packaging in a stable manner. The second adhesive has properties such that a sticky residue is not present when the top label is removed from the base label. A perforation pattern is provided. A method of advertising is also described.

### CROSS-REFERENCE TO RELATED APPLICATIONS

This application claims priority to U.S. Provisional Patent Application Ser. No. 61/592,705, filed Jan. 31, 2012, the disclosure of which is incorporated herein by reference in its entirety.

### FIELD

The technology described herein relates to advertising media in the form of a label that can be applied to media for advertising purposes.

### BACKGROUND

One form of advertising media is a label or booklet that can be applied to newsprint or products in order to include informational material on the product. Advertising media has also been known to include one or more coupons to encourage consumers to purchase a product. Oftentimes, labels and booklets have been attached in a permanent manner, where removal of the advertising material will result in damage to the underlying article. In other instances, removal is possible, but leaves an adhesive residue. In other instances, the label that attaches to the product or newsprint is transparent such that the transparent portion of the label remains on the product or newsprint even when the label or coupon is removed. This allows a user of the article to read material that is present under the transparent label, but causes issues with recycling of newspapers, since the newspaper is now corrupted with a plastic label.

### SUMMARY

Advertising media for application to a substrate is disclosed herein. A perforation pattern for use in high speed label applications is also disclosed. A method of advertising is further disclosed.

### BRIEF DESCRIPTION OF THE DRAWING FIGURES

FIG. 1 is top plan view of the example advertising media positioned on a liner;

FIG. 2 is a top plan view of the example advertising media with the top layer partially removed;

FIG. 3 is a cross-sectional enlarged side view of the example advertising media positioned on a liner in FIG. 1;

FIG. 4 is a cross-sectional enlarged exploded side view of the example advertising media from FIG. 3; and

FIG. 5 is a top plan view of a perforation pattern utilized with the example advertising media.

### DETAILED DESCRIPTION

The technology described herein relates generally to a label 12 for application to media. The label 12 may be in the form of a coupon or other single sheet media, or of a booklet that is folded into a rectangular or other shape. Booklets are known in the art and are also described in detail in applicants co-pending patent application, U.S. patent application Ser. No. 13/004,411, filed Jan. 11, 2011 and entitled “Booklet with Removable Adhesive Label,” the disclosure of which is incorporate herein by reference in its entirety. The example labels, referred to herein also as “advertising media” are designed for dispensing onto the pages of newspapers at high speeds. Alternatively, the example labels may be utilized on food containers or other containers that do not operate at speeds as high as those utilized with newspapers.

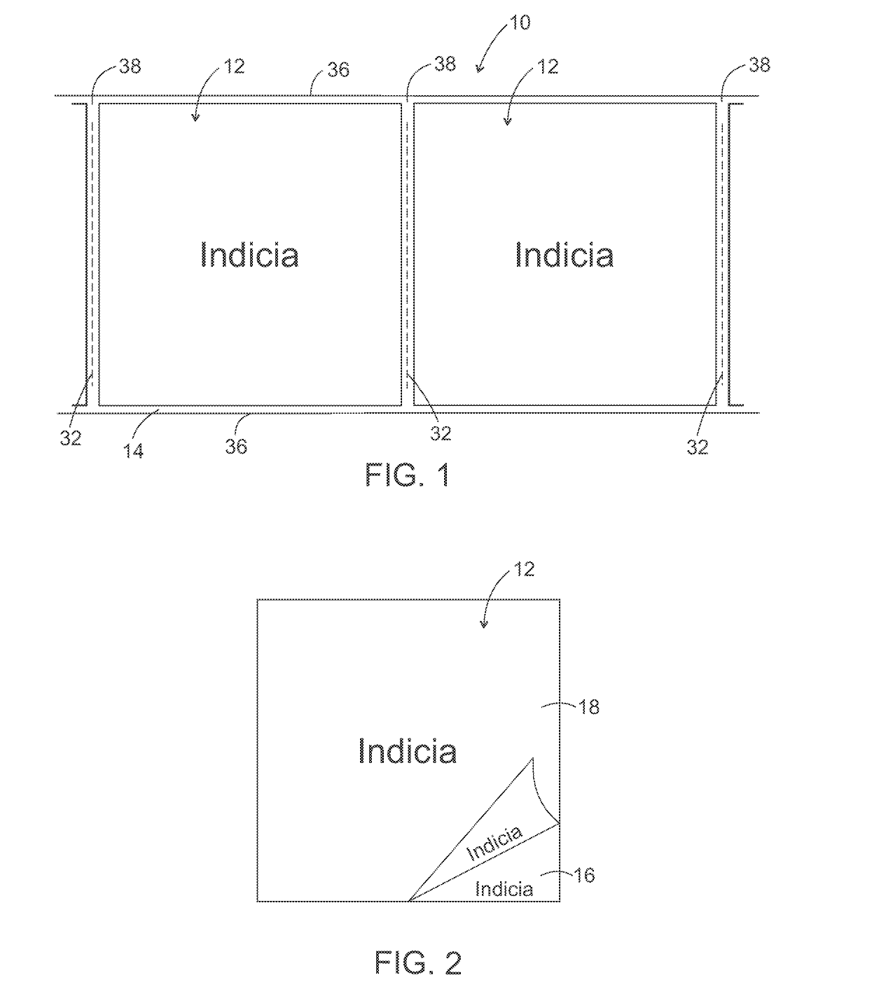

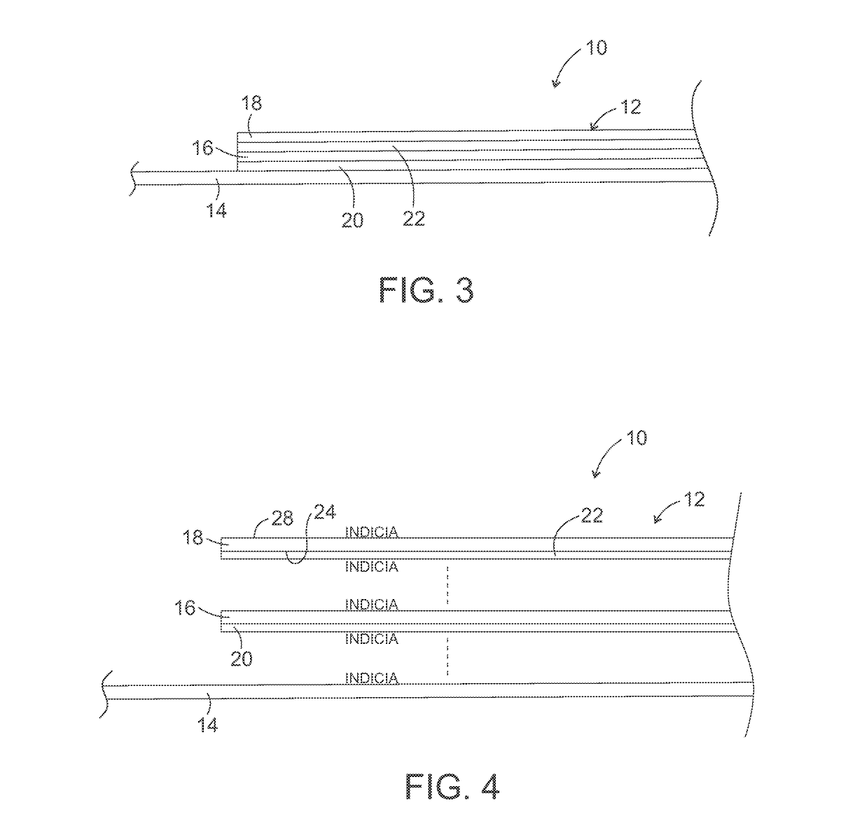

The example label 12 described herein, and as shown in FIGS. 1 and 2 incorporates a base label 16 and a top label 18 that are positioned on a liner 14 for dispensing. The base label 16 is typically a single sheet of stock, although it could be a multi-sheet booklet or the like. The top label 18 may be either a single sheet of stock or a multi-sheet booklet or the like. The base label 16 is for application to an underlying medium, such as a product or a newspaper. One example of placement for the base label 16 is on the front page of a newspaper or to the lid of a product.

Any number of different base labels 16 may be utilized with the example advertising media. One type of base label 16 is coupled to an underlying article by an ultra-removable adhesive 20. This type of adhesive 20 is typically low tack, but has strong peel strengths and can be removed without marring the underlying surface. Alternatively, the base label 16 may be provided with another removable or non-removable adhesive 20. In the case of newsprint, it is often desirable to be able to remove the base label 16 so that the underlying content is visible, in which case an ultra-removable adhesive 20 may be utilized so that the underlying newsprint is not damaged or marred, and the label itself is not damaged when removed. When removed, the base label 16 will typically remain sticky on the side that was adhered to the underlying article. This may provide a benefit in that a user can transfer the base label 16 from the newsprint to some other surface, much like a Post It™ note.

One type of adhesive 20 that may be utilized to couple the base label to an underlying surface is a fugitive adhesive, which provides a temporary bond between the underlying surface and the bottom of the base label 16. The fugitive adhesive dries clear, is non-staining, and leaves little or no residual tack on the underlying article, even though tack remains on the lower surface of the base label 16.

The top label 18 is coupled to an upper surface of the base label 16 via a second adhesive 22. The top label 18 is removable from the base label 16 by peeling at a corner or edge. When the top label 18 is removed, because of the type of second adhesive 22 that is used, no sticky adhesive surface is present on the lower surface 24 of the top label 18 or on the upper surface 26 of the base label 16. This allows the top label 18 to be used as a coupon that may be processed in standard automated coupon processing machines, among other uses.

Both the top surface 26 of the base label 16 and the top and bottom surfaces 28, 24 of the top label 18 may be printed and include advertising indicia. In addition, if desired, the bottom surface 30 of the base label 16 may also include advertising indicia and be printed.

Referring to the figures, FIG. 1 depicts a strip 10 of multi-layer labels 12 that is utilized before the multi-layer labels 12 are applied to an underlying surface. The strip 10 may be positioned on rolls and applied using a standard applicator (not shown). Alternatively, the strip 10 may be fan folded for use in other types of standard applicators (not shown). The strips 10 include a release liner 14, which is the bottom-most layer, a base label 16 and a top label 18. The base label 16 is positioned between the top label 18 and the liner 14. The base and top labels 16, 18, as shown, have the same dimensions and present as individual labels positioned on the underlying release liner 14. The release liner 14 is a continuous, substantially uninterrupted strip or sheet of material. As shown, the release liner 14 also has perforations 32 present between each label 12. These perforations 32 are utilized to allow the release liner 14 to bend when the strip of material 10 is moving through an application machine in order to help to ensure that labels 12 are properly placed on the underlying surface. The perforations 32 also serve a function that allows the liner 14 to bend when the labels 12 are positioned into a fan fold. The liner 14 may have a treatment that affects peel release in order to handle a stiffer product so that the labels 12 don't pre-dispense before they are supposed to.

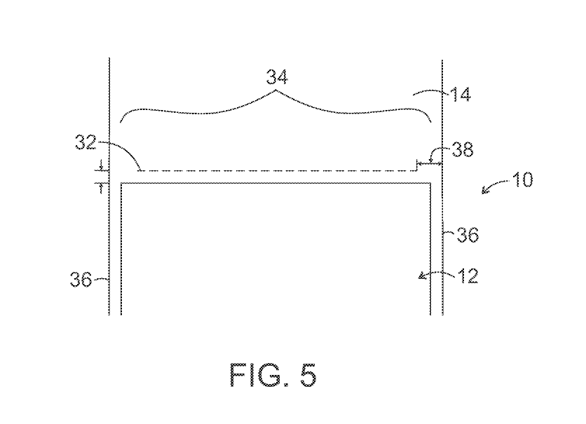

FIGS. 1 and 5 depict an example perforation pattern 34 that is useful in a high speed application. This perforation pattern 34 is particularly useful in the high flex fold, high torque applications. When labels 12 proceed through the label applicator, in order to remove the labels from the liner 14, the liner 14 is bent around a roller or other surface. Since the liner 14 is not as thick as the label and is not permanently attached to the liner 14, the label pulls away from the liner 14 while the liner 14 bends around the roller. Perforations 32 are provided in order to assist the liner 14 in bending at a location directly in front of the label 12 to assist in label release. The performance of the liner 14 is important because, if not designed properly, the labels 12 will prematurely release from the liner 14. The novel perforation pattern 34 shown in FIGS. 1 and 5 helps to allow the release liner 14 to fold or bend around the roller or other surface without releasing a label 12 prematurely.

The perforation pattern 34 is also useful in the context of high speed application machines that utilize labels 12 that are fan folded. During fan folding of the strip of material 10 during the manufacturing process, it is important to provide a clean fold. By perforating the liner 14 in the manner described herein, a clean fan fold can be accomplished.

The perforation pattern 34 is positioned between each label 12 and, in the example shown, is spaced about 1/16 inches from the edge of each label 12 on the liner 14. The perforations 32 are also spaced ¼ inch from the outer edges 36 of the release liner 14 so that the outer edges 36 of the release liner 14 do not have perforations. This provides sufficient strength so that the liner 14 does not tear when used in an application machine, but that allows the liner 14 to be folded. The perforations 32 may be cut into the release liner 14 during the manufacturing process using a roller with a blade, among other techniques for perforating the liner 14.

The example labels 12 shown in the figures are about 3×3 inches wide. The liner 14 has a width that is slightly larger than the width of the labels. When a 3 inch label is used, the liner 14 will typically have a width of about 3⅛ inches. Other shapes and sizes of labels may also be utilized with the invention described herein. For example, business card-size labels may be utilized or credit card-sized labels, such as those that are 2×3⅛ inches. The size of the label 12 is only limited by the type of application equipment that is available to the user. Labels 12 can be barcoded and sequentially numbered. If desired, they may have a writable area, such as on the back of a credit card. The bottom surface 24 of the top label 18 may be magnetized, if desired, so that a user can remove the top label 18 from the base label 16 and then apply it to a metal surface, such as the front of a refrigerator. Alternatively, the base label 16 bottom surface 30 can be magnetized. Other shapes and sizes may be used for the labels 12, not limited to rectangular shapes. For example, a cut out in the shape of a house could be used among other shapes. Multi-layer labels 12 may be utilized in addition to multi-layer panel booklet labels. For example, more than one top label 18 could be used.

Different types of adhesive 20, 22 are utilized to couple the base label 16 to the underlying substrate and to couple the top label 18 to the base label 16. The adhesive 22 that it used to couple the top label 18 to the base label 16, as discussed above, allows the top label 18 to be peeled away from the base label 16 without leaving a sticky residue on either the bottom surface of the top label 18 or on the upper surface of the base label 16. The adhesive does not mar either surface and ink does not substantially transfer from one surface to the other. This type of adhesive 22 could alternatively be used between the base label 16 and the liner 14. Adhesive 20, 22 is applied in an even coat over the entire surface between the top label 18 and the base label 16 and between the base label 16 and the liner 14. Alternatively, the adhesive 20, 22 could be applied in patterns, as known by those of skill in the art.

One type of middle ply adhesive 22 that may be utilized to couple the top label 18 to the base label 16 is TKG 50, which has a white liquid or clear appearance and a viscosity in the range of 1400-1500 CPS (Brookfield, 20 rpm, #4 spindle, 77° F.). This adhesive 22 has a weight of 8.3 lbs. per gallon, solids of 55+/−3%, and a pH of 6-7. FDA status of this product is pursuant to 21 C.F.R. 175.105 so that the adhesive can be utilized in connection with food products. Clean-up for this product is possible with warm, soapy water while still wet. Final clean-up is accomplished with solvent, such as acetone, ethyl acetate, or isopropanol. This adhesive 22 should be stored at temperatures below 90° F. and should be kept from freezing or excess heat or cold. If the product is frozen, it is unusable. The loop tack for this adhesive 22 is 140 to 300 grams, peel is 25 to 60 grams, liner release is 10 to 100 grams, coating weight is 2.3 to 3.2 lbs./ream, coating weight average is 2.8 lbs./ream and coating weight standard deviation is 0.23 lbs. per ream.

Another type of middle ply adhesive 22 that may be utilized to couple the top label 18 to the base label 16 is TKG 91, which has a clear to light amber liquid color and a viscosity in the range of 300-400 (Brookfield, 20 rpm, #4 spindle, 77° F.). This adhesive 22 has an abrasion resistance greater than 1000 Sutherland Dry Rub, a gloss of greater than 90 (60° head) and a weight of 9.3+/−0.1 lbs. per gallon. The adhesive 22 has 100% solids and a flash point that is greater than 220° F. This adhesive 22 should be stored at temperatures below 90° F. and should be kept away from sunlight, artificial light, and excessive heat. Low temperatures will thicken the product and high temperatures will thin the product. This adhesive 22 will cure to a tack free, dry to the touch, surface under 100 mg/cm². Belt velocity will depend on the number of lamps, power and spectral output of lamps and the efficiency of reflectors. This adhesive 22 has a loop tack of 40 to 150 grams, a peel of 25 grams max, a liner release of 15 to 100 grams, a coating weight of 2.3 to 3.2 lbs./ream, a coating weight average of 2.8 lbs./ream, and a coating weight standard deviation of 0.23 lbs./ream.

Other types of adhesives 22 may be used that dry without leaving a sticky residue, including adhesives that will be developed in the future or that are presently available.

A variety of adhesives 20 may be used to couple the bottom 30 of the base label 16 to an underlying substrate. These adhesives 20 can be used in all temperature ranges and can be applied with any known applicators. For example, when dispensing onto the pages of newspapers, high speeds are often necessary, such as speeds that range from 40,000-60,000 papers per hour. Thus, the adhesive 20 that is utilized to couple the base label 16 to the newspaper must have sufficient strength to adhere to the newspaper without coming off. In addition, the base label 16 must not prematurely dispense from the liner 14 when being applied by application machinery so that it never reaches the newsprint. If the adhesive 20 is too gummy, it may damage the newsprint or foul the printing press.

One type of adhesive 20 that may be utilized to couple the base label 16 to the newsprint or another underlying surface is an ultra-removable adhesive, such as that described in applicant's prior application, U.S. patent application Ser. No. 13/004,411, filed Jan. 11, 2011 and entitled “Booklet with Removable Adhesive Label.” For example, for newsprint having a 40% or less recycled content, this adhesive may have a peel strength of about 25-60 grams/1″ width, a loop tack ranging from about 140-30 grams/2″ width, and a liner release of about 10-60 grams/2″ width. Another type of adhesive 20 that is for use with newsprint having 40% or greater recycled content has a peel strength of about 10-25 grams/1″ width, a loop tack of about 40-150 grams/2″ width, and a liner release of about 15-150 grams/2″ width. One preferred adhesive 20 may be a microsphere-based adhesive. Other types of adhesive 20 may also be utilized.

Different types and thicknesses of paper stock may be utilized for the liner 14, base label 16, and top label 18. For example, the base and top label 16, 18 could be made of the same material having the same thickness, or could be made of different thicknesses of material and different types of material. One type of material that may be utilized for the top and base labels is 60 lb. per ream paper stock with or without sides of gloss. The label thicknesses can range from 40-80 lbs. per ream with or without gloss. The liner 14 may be a 52.5 lb. per ream material. Other liner 14 materials may also be used such as those ranging from about 40-60 lbs. per ream. Types of liner 14 materials that may be used include paper, poly coated paper, and polyester, among other types of materials. The liner 14 may be coated with a release agent, such as a silicon material (not shown).

The labels 12 described herein are manufactured in a known manner. The top and base labels 18, 16, may be die cut from the underlying release liner 14 during the manufacturing process. The paper stock may be printed in advance with an adhesive 20, 22 applied in advance, or may be printed with adhesive 20, 22 applied during the manufacturing process. The labels 12 are spaced from one another, with the release liner 14 being present in the spaces. A manufacturing process, similar to that discussed in applicants prior application, U.S. patent Ser. No. 13/004,411, may be utilized to manufacture the labels 12.

The example labels 12 described herein provides a means for advertising on the front page of a newspaper or on product packaging that allows a user to entirely remove the label 12 without marring the underlying product. In addition, the example labels 12 allow a user to remove part of the label, the top label 18, from the base label 16 in order to provide a coupon or magnetized label.

Advertising media for application to a substrate or product packaging via an applicator includes a release liner and a multi-part label coupled to the release liner. The multi-part label includes a base label coupled to the release liner with a first adhesive and a top label coupled to the base label with a second adhesive. The first adhesive has properties that allow the base label to be removed from the release liner and applied to a substrate or product packaging in a stable manner, but allows removal of the base label from the substrate or product packaging so as to not mar the substrate or product packaging or leave a residue thereon. The second adhesive has properties such that a sticky residue is not present when the top label is removed from the base label.

The release liner may be a strip of material and a plurality of multi-part labels may be positioned on the release liner in spaced succession Perforation may extend through the release liner between each of the multi-part labels. The strip of material may have a longitudinal axis and the perforations may be positioned perpendicular to the longitudinal axis of the strip of material, with the outer edges of the strip of material having a space 38 that is free of perforations. The free space 38 is about 0.25 inches long.

The labels may have a substantially rectangular shape and may be substantially evenly spaced from one another along the length of the strip. The first adhesive may be an ultra-removable adhesive or a fugitive adhesive. The second adhesive may have a loop tack in the range of 140 to 300 grams, a peel strength of 25 to 60 grams, a liner release of 10 to 100 grams and a coating weight of 2.3 to 3.2 lbs./ream; or the second adhesive may have a loop tack in the range of 40 to 150 grams, a peel strength maximum of 25 grams, a liner release of 15 to 100 grams, and a coating weight of 2.3 to 3.2 lbs./ream. The second adhesive may have an average coating weight of about 2.8 lbs./ream.

The first adhesive may cover an entire surface area of the base label and the second adhesive may cover an entire surface area of the top label. Indicia may be printed on at least an upper surface of the base label, a lower surface of the top label, and an upper surface of the top label.

A perforation pattern is provided for a strip of material that is utilized in label application using a label applicator. The strip of material has two long edges with a width defined between the edges, and a longitudinal axis. The perforation pattern includes a plurality of spaced slits extending through the strip of material in a direction that is perpendicular to the longitudinal axis of the strip of material and a space that is free from perforations positioned along each edge of the strip of material. The free space may be about 0.25 inches wide and the strip may be about 3.125 inches wide. The plurality of spaced slits each has about the same length and are evenly spaced from one another.

A method of advertising utilizing advertising media includes providing a multi-layer label on a strip of material, with the multi-layer label having at least a base label, and a top label, with a first adhesive provided between the base label and the strip of material, and a second different adhesive positioned between the base label and the top label. The method also includes providing printed indicia on one or more of the base label or the top label; removing the multi-layer label from the strip of material and applying it to a substrate with an automated label applicator; and peeling the top label from the base label of the multi-layer label. Sticky residue is not present on an upper layer of the base label or on a lower layer of the top layer when the top label is removed from the base label. The method may also include peeling the base label from the substrate. The removing and applying step may be accomplished at high speeds and the peeling step may be accomplished by hand.

The term “substantially,” if used herein, is a term of estimation.

While various features are presented above, it should be understood that the features may be used singly or in any combination thereof. Further, it should be understood that variations and modifications may occur to those skilled in the art to which the claimed examples pertain. The examples described herein are exemplary. The disclosure may enable those skilled in the art to make and use alternative designs having alternative elements that likewise correspond to the elements recited in the claims. The intended scope may thus include other examples that do not differ or that insubstantially differ from the literal language of the claims. The scope of the disclosure is accordingly defined as set forth in the appended claims.

What is claimed is:

1. Advertising media for application to a substrate or product packaging via an applicator comprising:
a release liner; and
a multi-part label coupled to the release liner in the form of a base label coupled to the release liner with a first adhesive and a top label coupled to the base label with a second adhesive;
wherein the first adhesive has properties that allow the base label to be removed from the release liner and applied to a substrate or product packaging in a stable manner, but being removable from the substrate or product packaging so as to not mar the substrate or product packaging or leave a residue thereon; and the second adhesive has properties such that a sticky residue is not present when the top label is removed from the base label.

2. The advertising media of claim 1, wherein the release liner is a strip of material and a plurality of multi-part labels are positioned on the release liner in spaced succession

3. The advertising media of claim 2, further comprising perforations extending through the release liner that are positioned between each multi-part label.

4. The advertising media of claim 3, wherein the strip of material has a longitudinal axis and the perforations are positioned perpendicular to the longitudinal axis of the strip of material, with the outer edges of the strip of material having a space that is free of perforations.

5. The advertising media of claim 4, wherein the space on the outer edges of the strip of material that is free of perforations is about 0.25 inches long.

6. The advertising media of claim 2, wherein the labels have a substantially rectangular space and are substantially evenly spaced from one another along the length of the strip.

7. The advertising media of claim 1, wherein the first adhesive is an ultra-removable adhesive or a fugitive adhesive.

8. The advertising media of claim 1, wherein the second adhesive has a loop tack in the range of 140 to 300 grams, a peel strength of 25 to 60 grams, a liner release of 10 to 100 grams and a coating weight of 2.3 to 3.2 lbs./ream; or the second adhesive has a loop tack in the range of 40 to 150 grams, a peel strength maximum of 25 grams, a liner release of 15 to 100 grams, and a coating weight of 2.3 to 3.2 lbs./ream.

9. The advertising media of claim 8, wherein the second adhesive has an average coating weight of about 2.8 lbs./ream.

10. The advertising media of claim 1, wherein the first adhesive covers an entire surface area of the base label and the second adhesive covers an entire surface area of the top label.

11. The advertising media of claim 1, wherein indicia is printed on at least an upper surface of the base label, a lower surface of the top label, and an upper surface of the top label.

12. A perforation pattern for a strip of material that is utilized in label application using a label applicator, with the strip of material having two long edges with a width defined between the edges, and a longitudinal axis, said perforation pattern comprising:
a plurality of spaced slits extending through the strip of material in a direction that is perpendicular to the longitudinal axis of the strip of material; and
a space that is free from perforations positioned along each edge of the strip of material.

13. The perforation pattern of claim 12, wherein the free space is about 0.25 inches wide and the strip is about 3.125 inches wide.

14. The perforation pattern of claim 12, wherein the plurality of spaced slits each has about the same length and are evenly spaced from one another.

15. A method of advertising utilizing advertising media, comprising;
providing a multi-layer label on a strip of material, said multi-layer label having at least a base label, and a top label, with a first adhesive provided between the base label and the strip of material, and a second different adhesive positioned between the base label and the top label;
providing printed indicia on one or more of the base label or the top label;
removing the multi-layer label from the strip of material and applying it to a substrate with an automated label applicator;
peeling the top label from the base label of the multi-layer label, wherein sticky residue is not present on an upper layer of the base label or on a lower layer of the top layer when the top label is removed from the base label.

16. The method of claim 15, further comprising peeling the base label from the substrate.

17. The method of claim 15, wherein the removing and applying step is accomplished at high speeds and the peeling step is accomplished by hand.
